(19) United States
(12) Patent Application Publication
(10) Pub. No.: US 2024/0015585 A1
(43) Pub. Date: Jan. 11, 2024

(54) RELAY NODE, MESH NETWORK SYSTEM AND DATA TRANSMISSION METHOD

(71) Applicant: Suzhou PanKore Integrated Circuit Technology Co. Ltd., Suzhou City (CN)

(72) Inventors: ZhaoMing LI, Suzhou City (CN); ZuoHui PENG, Suzhou City (CN)

(21) Appl. No.: 18/341,912

(22) Filed: Jun. 27, 2023

(30) Foreign Application Priority Data
Jul. 7, 2022 (CN) 202210794802.9

(51) Int. Cl. H04W 28/04; H04L 1/00; H04L 1/16

(52) U.S. Cl. CPC H04W 28/04; H04L 1/0061; H04L 1/16; H04W 84/18

(57) ABSTRACT

Disclosed is a data transmission method, including: generating a packet by a station, wherein a sending address of the packet is a MAC address of the station and a receiving address of the packet is a MAC address of an access point; changing the receiving address of the packet to a MAC address of its parent node by the station, and then sending the packet; transmitting an acknowledgement (ACK) frame by a relay node that receives the packet, changing the receiving address of the packet to a MAC address of its parent node, and then forwarding the packet uplink until the packet is forwarded to the access point; and transmitting an ACK frame by the access point after receiving the packet, parsing the packet, and determining that it receives data from the station based on the sending address of the packet.

### CROSS REFERENCE TO RELATED APPLICATION

The present disclosure claims the priority benefit of Chinese Patent Application Serial Number 202210794802.9, filed on Jul. 7, 2022, the full disclosure of which is incorporated herein by reference.

### BACKGROUND

### Technical Field

The present disclosure relates to the field of communication technologies, and, to a relay node, a mesh network system and a data transmission method.

### Related Art

In a wireless network, when there is a long distance between a station and an access point, the communication range of the access point can be extended by turning on a repeater device in a repeater mode, so that the station falls within the better signal range of the access point. The data forwarding process between the station and the access point through the relay device comprises: sending, by the station, a packet to the relay device through a SoftAP port of the relay device, and forwarding, by the relay device, the packet received to the access point through a STA Port of itself to implement communication between the station and the access point. However, in the above data forwarding process, the relay device needs to use the SoftAP port and the key of the station to decrypt the received packet, and needs to use the STA port and the key of the access point to encrypt the packet to be forwarded, and the data forwarding process involves the mapping conversion of the TCP/IP protocol layer between the SoftAP port and the STA port. Therefore, the relay device needs upper-layer software to process data, and there is a problem that the data forwarding process is relatively complicated.

In addition, in the existing mesh network used to expand the coverage of the wireless network, each node usually needs to establish and maintain routing table information in order to forward packets correctly. During the data forwarding process, if the target MAC address of the packet is in the routing table of the current node and is not the MAC address of the current node itself, the current node chooses to forward the packet downlink to the child node corresponding to the sub-routing table containing the destination MAC address. However, in the above data forwarding process, because the packet needs to be transmitted to the upper-layer software of the current node to determine which node to continue to transmit the packet by querying the routing table information, there is a problem that the data forwarding process is relatively complicated.

Therefore, there is an urgent need for a relay node, a mesh network system and a data transmission method that make the data forwarding process relatively simple.

### SUMMARY

The embodiments of the present disclosure provide a relay node, a mesh network system, and a data transmission method, which can solve the problem of a relatively complicated data forwarding process in a wireless network in the prior art.

In order to solve above-mentioned technical problem, the present disclosure is implemented as follows.

In a first aspect, the present disclosure provides a data transmission method, including: generating a packet by a station, wherein a sending address of the packet is a MAC address of the station and a receiving address of the packet is a MAC address of an access point; changing the receiving address of the packet to a MAC address of its parent node by the station, and then sending the packet; transmitting an acknowledgment (ACK) frame by a relay node that receives the packet, changing the receiving address of the packet to a MAC address of its parent node, and then forwarding the packet uplink until the packet is forwarded to the access point; and transmitting an ACK frame by the access point after receiving the packet, parsing the packet, and determining that it receives data from the station based on the sending address of the packet.

In the second aspect, the present disclosure further provides another data transmission method, including: sending a packet by an access point, wherein a receiving address of the packet is a MAC address of a station and a sending address of the packet is a MAC address of the access point; receiving the packet by a relay node based on the MAC address of the station contained in a refugee table stored in the relay node and the sending address of the packet being a MAC address of its parent node, transmitting an ACK frame to its parent node, and then changing the sending address of the packet to its own MAC address and forwarding the packet downlink until the packet is forwarded to the station, wherein the refugee table stored in the relay node contains MAC addresses of all descendant nodes that provided with relay services by the relay node; and receiving the packet by the station based on the sending address of the packet being the MAC address of its parent node and the receiving address of the packet being the MAC address of the station, transmitting an ACK frame, changing the sending address of the packet to the MAC address of the access point, and then determining that it receives data from the access point based on the sending address of the packet.

In a third aspect, the present disclosure provides a mesh network system, including: a station, an access point and a relay node. The station is configured to generate a packet, a sending address of the packet is a MAC address of itself, and a receiving address of the packet is a MAC address of an access point, and the station is further configured to change the receiving address of the packet to a MAC address of its parent node, and then send the packet. The relay node is configured to perform an uplink forwarding procedure after receiving the packet, wherein the uplink forwarding procedure comprises: transmitting an ACK frame, changing the receiving address of the packet received to a MAC address of its parent node, and then forwarding the packet uplink; when the number of the relay nodes is multiple and hierarchically connected, each relay node executes the uplink forwarding procedure until the packet is forwarded to the access point. The access point is configured to transmit an ACK frame after receiving the packet, parse the packet, and then determine that it receives data from the station based on the sending address of the packet.

In a fourth aspect, the present disclosure further provides another mesh network system, including: a station, an access point, and a relay node. The access point is configured to send the packet, wherein a receiving address of the packet is a MAC address of a station and a sending address of the packet is a MAC address of the access point. The relay node is configured to perform a downlink forwarding procedure, wherein the downlink forwarding procedure comprises: receiving the packet based on the MAC address of the station contained in a refugee table stored in the relay node and the sending address of the packet being a MAC address of its parent node, transmitting an ACK frame to its parent node, and then changing the sending address of the packet to a MAC address of itself and forwarding the packet downlink; the refugee table stored in the relay node contains MAC addresses of all descendant nodes that provided with relay services by the relay node; when the number of the relay nodes is multiple and hierarchically connected, each relay node executes the downlink forwarding procedure until the packet is forwarded to the station The station is configured to receive the packet based on the sending address of the packet being a MAC address of its parent node and the receiving address of the packet being a MAC address of itself, transmit an ACK frame, change the sending address of the packet received to the MAC address of the access point, and then determine that it receives data from the access point based on the sending address of the packet.

In a fifth aspect, the present disclosure provides a relay node, including: a storage circuit, a filtering and return circuit, an address change circuit, and a sending circuit. The storage circuit is configured to store a refugee table, wherein the refugee table contains MAC addresses of all descendant nodes provided with relay services by the relay node. The filtering and return circuit is coupled to the storage circuit, and is configured to receive a first packet, transmit an ACK frame to a parent node, and determine that the first packet needs to be forwarded downlink, wherein a receiving address of the first packet is stored in the refugee table, and a sending address of the first packet is a MAC address of the parent node. The filtering and return circuit is configured to receive a second packet sent by a child node, transmit an ACK frame to the child node, and determine that the second packet needs to be forwarded uplink, wherein a receiving address of the second packet is a MAC address of the relay node. The address change circuit is coupled to the filtering and return circuit, and is configured to change the sending address of the first packet that the filtering and return circuit determines needs to be forwarded downlink to the MAC address of the relay node, and change the receiving address of the second packet that the filtering and return circuit determines needs to be forwarded uplink to the MAC address of the parent node. The sending circuit is coupled to the address change circuit, and is configured to sending the first packet whose sending address is changed by the address change circuit and the second packet whose receiving address is changed by the address change circuit.

In the embodiments of the present disclosure, the relay node implements data forwarding based on the modification of the receiving address or sending address of the packet, so that the data forwarding process does not involve encryption and decryption of packets, the routing table information does not need to be maintained, the logic is simple, there is no requirement for additional special protocols for the software, the relay node has the advantages of fast and high efficient, and the relay node solves the problem of relatively complicated data forwarding process in wireless networks. In addition, during the data forwarding process, the station considers that the station is coupled to the access point, the access point considers that the access point is coupled to the station, and the station and the access point do not become aware of the existence of the relay node.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 is a flowchart of a method for pairing nodes according to a first embodiment of the present disclosure;

FIG. 2 is a schematic diagram of a format of a pairing request packet according to an embodiment of the present disclosure;

FIG. 3 is a schematic diagram of a format of a pairing approval packet according to an embodiment of the present disclosure;

FIG. 4 is a schematic diagram of a mesh network system according to an embodiment of the present disclosure;

FIG. 5 is a schematic diagram of a relay node according to an embodiment of the present disclosure;

FIG. 6 is a schematic diagram of a node to be paired according to an embodiment of the present disclosure;

FIGS. 7 and 8 are a flowchart of a first embodiment of a method for pairing nodes in which the node to be paired in FIG. 6 joins the mesh network system in FIG. 4;

FIG. 9 is a flowchart of a method for pairing nodes according to a second embodiment of the present disclosure;

FIG. 10 is a schematic diagram of a format of a pairing rejection packet according to an embodiment of the present disclosure;

FIG. 11 is a flowchart of a second embodiment of a method for pairing nodes in which the node to be paired in FIG. 6 joins the mesh network system in FIG. 4;

FIG. 12 is a flowchart of a method for pairing nodes according to a third embodiment of the present disclosure;

FIG. 13 is a flowchart of a method for pairing nodes according to a fourth embodiment of the present disclosure;

FIG. 14 is a flowchart of a data transmission method according to a first embodiment of the present disclosure;

FIG. 15 is a schematic diagram of a format of a packet generated by a station according to an embodiment of the present disclosure;

FIG. 16 is a schematic diagram of a mesh network system according to another embodiment of the present disclosure;

FIG. 17 is a schematic diagram of a relay node according to another embodiment of the present disclosure;

FIGS. 18 and 19 are a flowchart of an embodiment of a data transmission method in which a third-level node transmits a packet to an access point in FIG. 16;

FIGS. 20 and 21 are a flowchart of another embodiment of a data transmission method in which a third-level node transmits a packet to an access point in FIG. 16;

FIG. 22 is a flowchart of a data transmission method according to a second embodiment of the present disclosure;

FIGS. 23 and 24 are a flowchart of an embodiment of a data transmission method in which an access point transmits a packet to a third-level node in FIG. 16; and

FIGS. 25 and 26 are a flowchart of another embodiment of a data transmission method in which an access point transmits a packet to a third-level node in FIG. 16.

### DETAILED DESCRIPTION OF THE EMBODIMENTS

The following embodiments describe the features and advantages of the present disclosure in detail, but do not limit the scope of the present disclosure in any point of view. According to the description, claims, and drawings, a person ordinarily skilled in the art can easily understand the technical content of the present disclosure and implement it accordingly.

The embodiments of the present disclosure will be described below in conjunction with the relevant drawings. In the figures, the same reference numbers refer to the same or similar components or method flows.

It must be understood that the words “including”, “comprising” and the like used in this specification are used to indicate the existence of specific technical features, values, method steps, work processes, elements and/or components. However, it does not exclude that more technical features, values, method steps, work processes, elements, components, or any combination of the above can be added.

It must be understood that when an element is described as being “connected” or “coupled” to another element, it may be directly connected or coupled to another element, and intermediate elements therebetween may be present. In contrast, when an element is described as “directly connected” or “directly coupled” to another element, there is no intervening element therebetween.

Before a relay node, a mesh network system and a data transmission method of the present disclosure are described, the nouns of the present disclosure are explained first. The noun “mesh network system” mentioned in the present disclosure refers to a mesh communication network formed by network nodes communicating with each other. The noun “network node” refers to a computing device coupled to a network with independent addressing, transmitting or receiving data capabilities, such as a workstation, a server, a terminal device, and a network device, wherein the network node with the relay function is called a relay node, and the network node without the relay function is called a station (STA). All network nodes can provide the STA function working as a station in the infrastructure mode defined by the 802.11 protocol, so the relay node can execute different programs to play the role of a station. It should be noted that, for a relay node, the MAC addresses used for the STA function and the MAC addresses used for the relay function can be the same or different. The network node/relay node directly coupled to an access point (AP) is called a root node. The network node coupled to the access point through the root node is called a second-level node, the network node coupled to the access point through the second-level node is called a third-level node, and so on. For two network nodes that are directly coupled to each other, the upper-level network node is called a parent node of the lower-level network node, and the lower-level network node is called a child node of the upper-level network node. Each network node has only one parent node, and a parent node can have many child nodes. It can be considered that the access point is the parent node of the root node. The network node whose level is greater than the level of a certain network node is called the subordinate node of the certain network node. For example, the third-level node, the fourth-level node, and the fifth-level node are all subordinate nodes of the second-level node. All subordinate nodes that need to communicate with the access point through a certain network node are called descendant nodes of the certain network node. In addition, the “refugee table” stored in a relay node mentioned in the present disclosure is used for recording the relevant information of the descendant nodes of the relay node, such as a MAC address and a variant on the MAC address, wherein the variant on the MAC address is the result of the hash calculation of the MAC address, or the result of the cyclic redundancy check (CRC) calculation of the MAC address. In the following embodiments, the refugee table stored in a relay node is used for recording the MAC addresses of descendant nodes of the relay node for illustration. Furthermore, the “MAC address of the access point” mentioned in the present disclosure refers to the basic service set identifier (BS SID) of the access point.

During the construction process of the mesh network system, each relay node can establish the content of the refugee table stored by itself, and each network node can confirm its own parent node. Therefore, it is necessary to explain the construction process of the mesh network system before a relay node, a mesh network system and a data transmission method of the present disclosure are described.

In the construction process of the mesh network system, the network node as the root node can establish its connection with the access point through the existing method for pairing nodes, which is not described herein. The network node as the non-root node (hereinafter referred to as a node to be paired) can confirm its own parent node and join the mesh network system through the following method for pairing nodes, and make each relay node of the mesh network system update the content of the refugee table stored by itself.

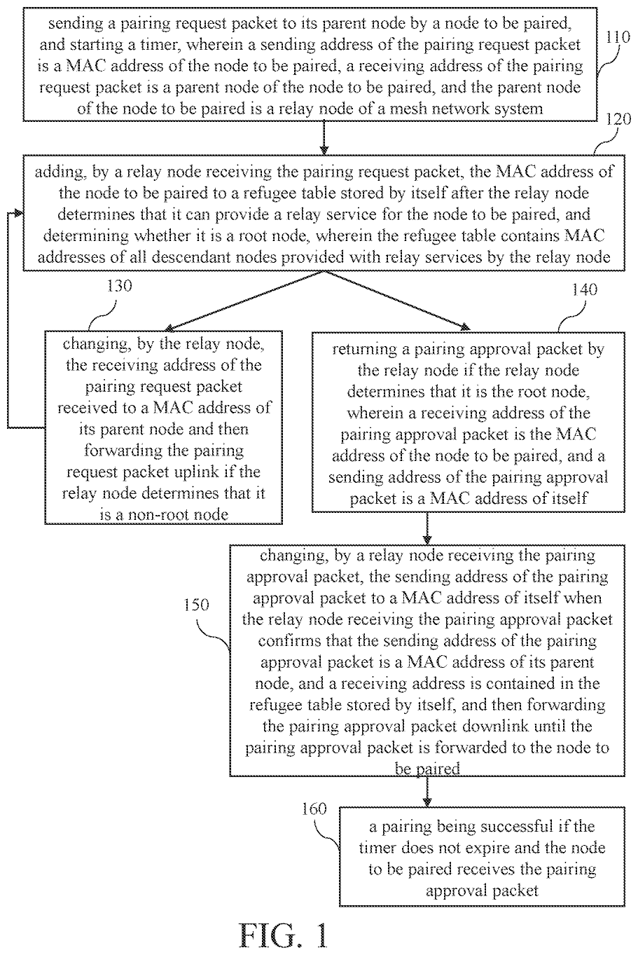

Please refer to FIG. 1, which is a flowchart of a method for pairing nodes according to a first embodiment of the present disclosure. The method for pairing nodes comprises: sending a pairing request packet to its parent node by a node to be paired, and starting a timer, wherein a sending address of the pairing request packet is a MAC address of the node to be paired, a receiving address of the pairing request packet is a parent node of the node to be paired, and the parent node of the node to be paired is a relay node of a mesh network system (step 110); adding, by a relay node receiving the pairing request packet, the MAC address of the node to be paired to a refugee table stored by itself after the relay node determines that it can provide a relay service for the node to be paired, and determining whether it is a root node, wherein the refugee table contains MAC addresses of all descendant nodes provided with relay services by the relay node (step 120); changing, by the relay node, the receiving address of the pairing request packet received to a MAC address of its parent node and then forwarding the pairing request packet uplink if the relay node determines that it is a non-root node (step 130); returning a pairing approval packet by the relay node if the relay node determines that it is the root node, wherein a receiving address of the pairing approval packet is the MAC address of the node to be paired, and a sending address of the pairing approval packet is a MAC address of itself (step 140); changing, by a relay node receiving the pairing approval packet, the sending address of the pairing approval packet to a MAC address of itself when the relay node receiving the pairing approval packet confirms that the sending address of the pairing approval packet is a MAC address of its parent node, and a receiving address is contained in the refugee table stored by itself, and then forwarding the pairing approval packet downlink until the pairing approval packet is forwarded to the node to be paired (step 150); a pairing being successful if the timer does not expire and the node to be paired receives the pairing approval packet (step 160). It should be noted that, when the parent node of the node to be paired is the root node, step 130 and step 150 may be omitted.

Each of the format of the pairing request packet and the pairing approval packet can be a frame defined by the 802.11 protocol, such as a data frame, a management frame, a control frame, and other self-defined frames, and the pairing request packet and the pairing approval packet can use the same type of packet having different meanings or use different types of packets.

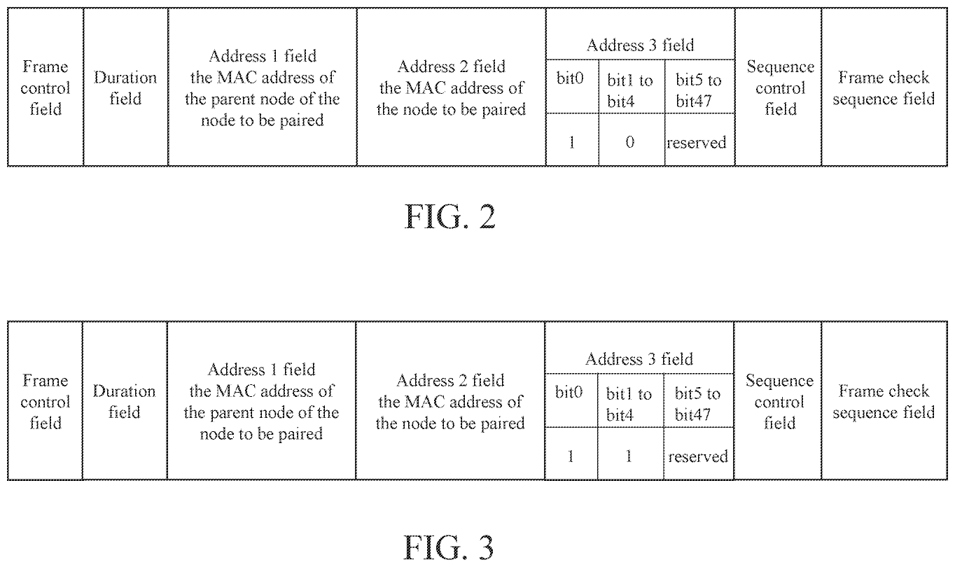

In one embodiment, the format of the pairing request packet may be a null data frame defined by the 802.11 protocol. The null data frame comprises a frame control field, a duration field, an address 1 field, an address 2 field, an address 3 field, a sequence control field, and a frame check sequence field. Specifically, sending the pairing request packet by the node to be paired in step 110 comprises: filling, by the node to be paired, an address 1 field in a null data frame with the MAC address of the parent node of the node to be paired, filling an address 2 field with the MAC address of the node to be paired, setting a first preset bit of the address 3 field to a first preset value to define the null data frame as a handshake frame, setting a plurality of second preset bits of an address 3 field to a third preset value to define a type of the handshake frame as a pairing request, so as to generate and send the pairing request data packet. In an example, a first preset bit of the address 3 field may be bit0, the first preset value may be 1 (that is, bit0 is 1), the plurality of second preset bits of the address 3 field may be bit1 to bit4, the third preset value may be 0 (that is, bit1 to bit4 are all 0), and other bits of the address 3 field (that is, bit5 to bit47) may be reserved for encoding, so that the handshake frame carries the pairing related information, as shown in FIG. 2, which is a schematic diagram of a format of a pairing request packet according to an embodiment of the present disclosure. It should be noted that although the value of bit0 of the address 3 field defined by the 802.11 protocol is 1, which indicates a multicast address, the null data frame does not include a multicast address in actual use, so that this feature can be used to allow hardware and software to easily recognize that it is the packet defined in the present disclosure.

In addition, the format of the pairing approval packet can also be a null data frame defined by the 802.11 protocol. Specifically, returning a pairing approval packet by the relay node if the relay node determines that it is the root node in step 140, comprises: filling, by the root node, the address 1 field in the null data frame with the MAC address of the node to be paired, filling the address 2 field with the MAC address of the root node, setting a first preset bit of the address 3 field to a first preset value to define the null data frame as a handshake frame, setting a plurality of second preset bits of the address 3 field to a fourth preset value to define a type of the handshake frame as pairing approval, so as to generate and return the pairing approval packet. In an example, the first preset bit of the address 3 field may be bit0, the first preset value may be 1 (that is, bit0 is 1), the plurality of second preset bits of the address 3 field may be bit1 to bit4, the fourth preset value may be 1 (that is, bit1 to bit3 are all 0, and bit4 is 1), and other bits of the address 3 field (that is, bit5 to bit47) may be reserved for encoding, so that the handshake frame carries the pairing related information as shown in FIG. 3, which is a schematic diagram of a format of a pairing approval packet according to an embodiment of the present disclosure.

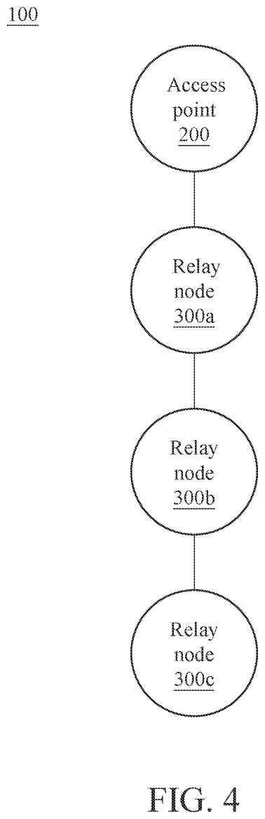

More specifically, the description of the method for pairing nodes shown in FIG. 1 is described below in conjunction with FIG. 4 to FIG. 8 as an embodiment.

Please refer to FIG. 4, which is a schematic diagram of a mesh network system according to an embodiment of the present disclosure. As shown in FIG. 4, the mesh network system 100 comprises an access point 200 and a plurality of network nodes, the plurality of network nodes can communicate with each other through the mesh network, and the plurality of network nodes comprise a plurality of relay nodes (i.e., the relay node 300a, the relay node 300b, and the relay node 300c), wherein the relay node 300a serves as the root node communicating with the access point 200, the parent node of the relay node 300c is the relay node 300b, and the parent node of the relay node 300b is the relay node 300a.

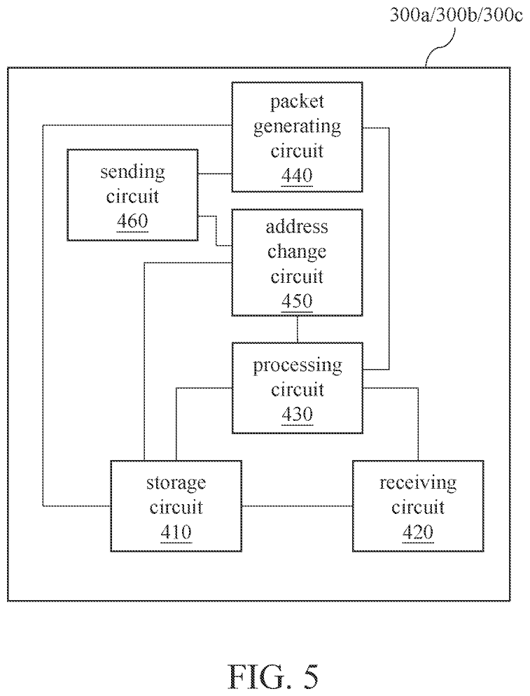

Please refer to FIG. 5, which is a schematic diagram of a relay node according to an embodiment of the present disclosure. The relay node 300a, the relay node 300b and the relay node 300c may all comprise: a storage circuit 410, a receiving circuit 420, a processing circuit 430, a packet generating circuit 440, an address change circuit 450 and a sending circuit 460, wherein the receiving circuit 420 is coupled to the storage circuit 410, the processing circuit 430 is coupled to the receiving circuit 420 and the storage circuit 410, the packet generation circuit 440 is coupled to the processing circuit 430, the address change circuit 450 is coupled to the storage circuit 410 and the processing circuit 430, the sending circuit 460 is coupled to the address change circuit 450 and the packet generation circuit 440, and the storage circuit 410 is configured to store the refugee table. The receiving circuit 420, the processing circuit 430, the packet generating circuit 440, the address change circuit 450 and the sending circuit 460 may be implemented as software, hardware, and an appropriate combination thereof. The software circuit may be stored in a storage medium in the art, and do its work through the processor. For example, if the above-mentioned circuits are all software circuits, they can work by the same processor, or by different processors in any combination.

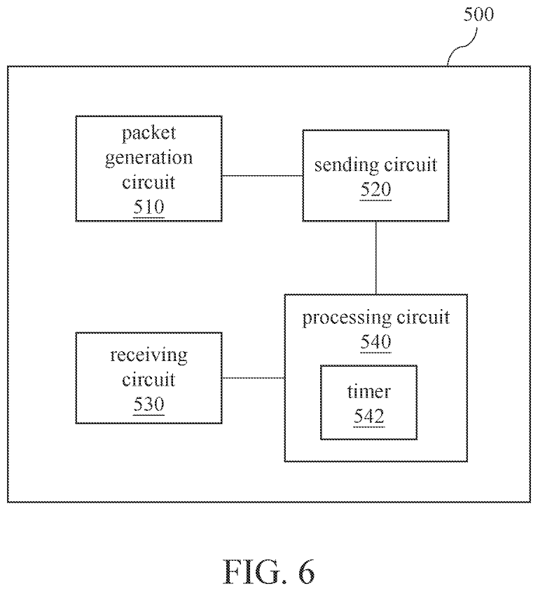

Please refer to FIG. 6, which is a schematic diagram of a node to be paired according to an embodiment of the present disclosure. The node to be paired 500 is a node that intends to join the mesh network system 100. The node to be paired 500 comprise a packet generation circuit 510, a sending circuit 520, a receiving circuit 530, and a processing circuit 540, wherein the sending circuit 520 is coupled to the packet generation circuit 510, and the processing circuit 540 is coupled to the sending circuit 520 and the receiving circuit 530, and the processing circuit 540 comprises a timer 542. The packet generation circuit 510, the sending circuit 520, the receiving circuit 530 and the processing circuit 540 can be implemented as software, hardware, and an appropriate combination thereof. The software circuit may be stored in a storage medium in the art, and do its work through the processor. For example, if the above-mentioned circuits are all software circuits, they can work by the same processor, or by different processors in any combination.

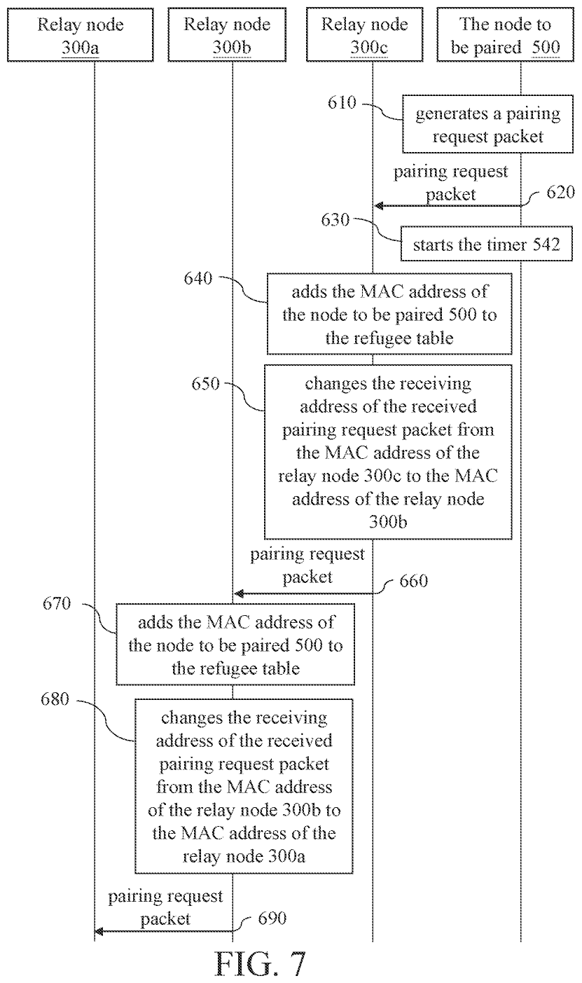

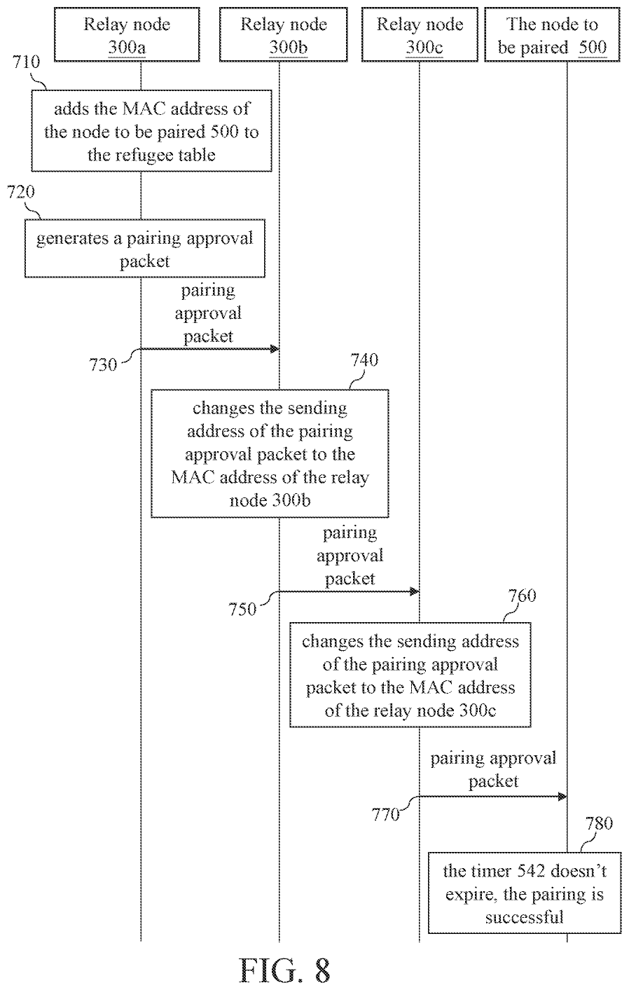

Please refer to FIG. 4 to FIG. 8, wherein FIGS. 7 and 8 are a flowchart of a first embodiment of a method for pairing nodes in which the node to be paired in FIG. 6 joins the mesh network system in FIG. 4. When the to-be-paired node 500 in FIG. 6 intends to join the mesh network system 100 in FIG. 4, the to-be-paired node 500 generates a pairing request packet by the packet generation circuit 510 thereof (step 610), the to-be-paired node 500 sends the pairing request packet to the relay node 300c by the sending circuit 520 thereof (step 620), and starts the timer 542 of the to-be-paired node 500 (step 630), wherein the parent node of the node to be paired 500 is the relay node 300c, the sending address of the pairing request packet is the MAC address of the node to be paired 500, and the receiving address of the pairing request packet is the MAC address of the relay node 300c. Since the receiving address of the pairing request packet is the MAC address of the relay node 300c, the relay node 300c receives the pairing request packet by the receiving circuit 420. When the processing circuit 430 of the relay node 300c determines that the relay node 300c can provide the relay service for the node to be paired 500, based on the sending address of the pairing request packet being the MAC address of the node to be paired 500, the MAC address of the node to be paired 500 is added to the refugee table stored in storage circuit 410 of the relay node 300c (step 640), and the relay node 300c determines whether the relay node 300c is the root node. When the processing circuit 430 of the relay node 300c determines that the relay node 300c is a non-root node, the relay node 300c changes the receiving address of the received pairing request packet from the MAC address of the relay node 300c to the MAC address of the relay node 300b by the address change circuit 450 thereof (step 650), and the sending circuit 460 of the relay node 300c sends the pairing request packet with the receiving address changed by the address change circuit 450 to the relay node 300b (step 660).

Since the receiving address of the pairing request packet is the MAC address of the relay node 300b, the relay node 300b receives the pairing request packet by the receiving circuit 420 thereof. When the processing circuit 430 of the relay node 300b determines that the relay node 300b can provide the relay service for the node to be paired 500, based on the sending address of the pairing request packet being the MAC address of the node to be paired 500, the MAC address of the node to be paired 500 is added to the refugee table stored in the storage circuit 410 of the relay node 300b (step 670). When the processing circuit 430 of the relay node 300b determines that the relay node 300b is a non-root node, the relay node 300b changes the receiving address of the received pairing request packet from the MAC address of the relay node 300b to the MAC address of the relay node 300a by the address change circuit 450 thereof (step 680), and the sending circuit 460 of the relay node 300b sends the pairing request packet whose receiving address is changed by the address change circuit 450 to the relay node 300a (step 690).

Since the receiving address of the pairing request packet is the MAC address of the relay node 300a, the relay node 300a receives the pairing request packet by the receiving circuit 420 thereof. When the processing circuit 430 of the relay node 300a determines that the relay node 300a can provide the relay service for the node to be paired 500, based on the sending address of the pairing request packet being the MAC address of the node to be paired 500, the MAC address of the node to be paired 500 is added to the refugee table stored in the storage circuit 410 of the relay node 300a (step 710). When the processing circuit 430 of the relay node 300a determines that the relay node 300a is the root node, the relay node 300a generates a pairing approval packet by the packet generation circuit 440 thereof (step 720), and the sending circuit 460 of the relay node 300a sends the pairing approval packet generated by the packet generation circuit 440 to the relay node 300b (step 730), wherein the receiving address of the pairing approval packet is the MAC address of the node to be paired 500 and the sending address of the pairing approval packet is the MAC address of the relay node 300a.

Since the sending address of the pairing approval packet is the MAC address of the relay node 300a, and the receiving address of the pairing approval packet is contained in the refugee table stored in the storage circuit 410 of the relay node 300b, the relay node 300b receives the pairing approval packet by the receiving circuit 420 thereof, and changes the sending address of the pairing approval packet to the MAC address of the relay node 300b by the address change circuit 450 thereof (step 740), and the sending circuit 460 of the relay node 300b sends the pairing approval packet whose sending address is changed by the address change circuit 450 to the relay node 300c (step 750). Since the sending address of the pairing approval packet is the MAC address of the relay node 300b, and the receiving address is contained in the refugee table stored in the storage circuit 410 of the relay node 300c, the relay node 300c receives the pairing approval packet, and changes the sending address of the pairing approval packet to the MAC address of the relay node 300c by the address change circuit 450 thereof (step 760), and the sending circuit 460 of the relay node 300c sends the pairing approval packet whose sending address is changed by the address change circuit 450 to the node to be paired 500 (step 770).

Since the receiving address of the pairing approval packet is the MAC address of the node to be paired 500, the node to be paired 500 receives the pairing approval packet by the receiving circuit 530 thereof. If the receiving circuit 530 of the node to be paired 500 receives the pairing approval packet, and the timer 542 of the to-be-paired node 500 does not expire, it means that the pairing is successful (step 780) (that is, the node to be paired 500 successfully joins the mesh network system 100).

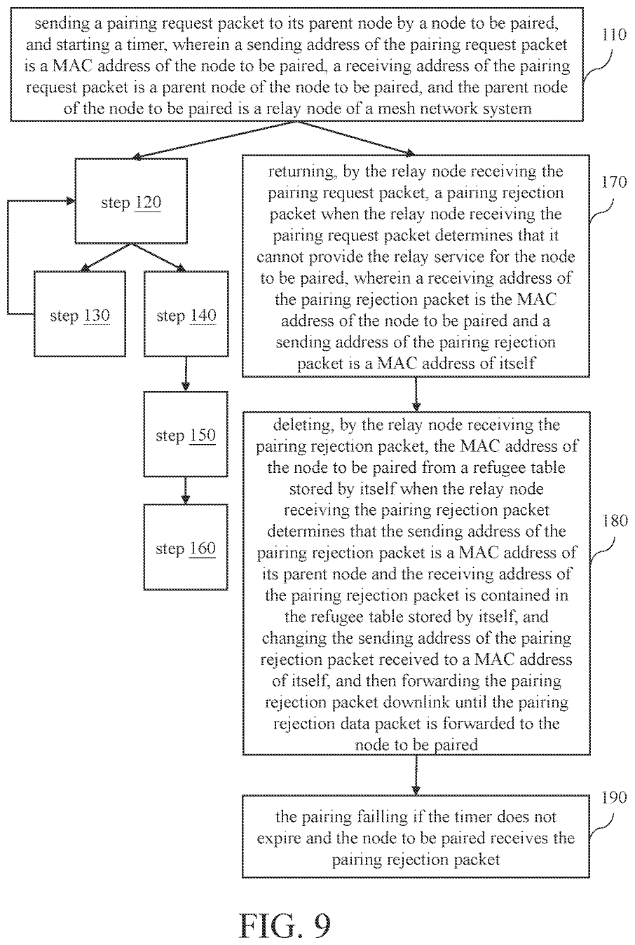

Please refer to FIG. 9, which is a flowchart of a method for pairing nodes according to a second embodiment of the present disclosure. In addition to the step 110 to step 160 described above, the method for pairing nodes may further comprise: returning, by the relay node receiving the pairing request packet, a pairing rejection packet when the relay node receiving the pairing request packet determines that it cannot provide the relay service for the node to be paired, wherein a receiving address of the pairing rejection packet is the MAC address of the node to be paired and a sending address of the pairing rejection packet is a MAC address of itself (step 170); deleting, by the relay node receiving the pairing rejection packet, the MAC address of the node to be paired from a refugee table stored by itself when the relay node receiving the pairing rejection packet determines that the sending address of the pairing rejection packet is a MAC address of its parent node and the receiving address of the pairing rejection packet is contained in the refugee table stored by itself, and changing the sending address of the pairing rejection packet received to a MAC address of itself, and then forwarding the pairing rejection packet downlink until the pairing rejection data packet is forwarded to the node to be paired (step 180); and the pairing failing if the timer does not expire and the node to be paired receives the pairing rejection packet (step 190). It should be noted that, when the relay node determines that it cannot provide the relay service for the node to be paired, and the relay node that returns the pairing rejection packet is the parent node of the node to be paired, step 180 may be omitted.

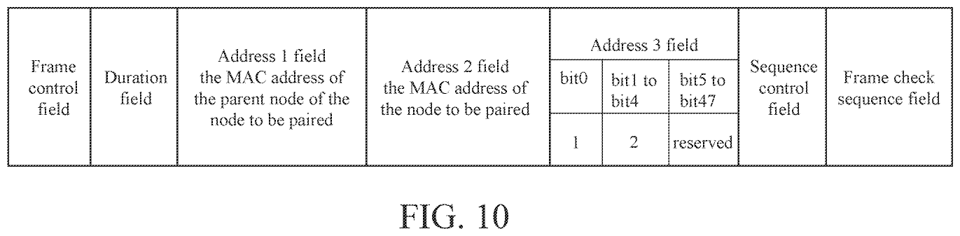

The format of the pairing rejection packet may be a data frame defined by the 802.11 protocol, such as a management frame, a control frame, and other self-defined frames. In one embodiment, the format of the pairing rejection packet may also be a null data frame defined by the 802.11 protocol. Specifically, returning, by the relay node receiving the pairing request packet, a pairing rejection packet when the relay node receiving the pairing request packet determines that it cannot provide the relay service for the node to be paired in step 170, further comprises: filling, by the relay node receiving the pairing request packet, the address 1 field in the null data frame with the MAC address of the node to be paired, filling the address 2 field with a MAC address of itself, setting a first preset bit of the address 3 field to a first preset value to define the null data frame as a handshake frame, and setting a plurality of second preset bits of the address 3 field to a second preset value to define a type of the handshake frame as a pairing rejection, so as to generate and return the pairing rejection packet. In an example, the first preset bit of the address 3 field may be bit0, the first preset value may be 1, the plurality of second preset bits of the address 3 field may be bit1 to bit4, the second preset value may be 2 (that is, bit1, bit2, and bit4 are all 0, and bit3 is 1), and the other bits of the address 3 field (that is, bit5 to bit47) may be reserved for encoding, so that the handshake frame carries the pairing related information, as shown in FIG. 10, which is a schematic diagram of a format of a pairing rejection packet according to an embodiment of the present disclosure.

In one embodiment, the situation that the relay node determines that it cannot provide the relay service for the node to be paired may comprise but not limited to: (1) the situation where the storage capacity of the refugee table of the relay node has reached a upper limit value, so that the relay node can no longer provide relay services for more network nodes; (2) the situation where the relay node shuts down the relay service function; (3) the situation where the relay node is trying to switch to connect to other network nodes; and (4) the situation where the relay node has left the mesh network system.

It should be noted that, the relay node determining that it cannot provide the relay service for the node to be paired in step 170 may be a root node or a non-root node.

More specifically, the description of the method for pairing nodes shown in FIG. 9 is described below in conjunction with FIG. 4 to FIG. 6 and FIG. 11 as an embodiment.

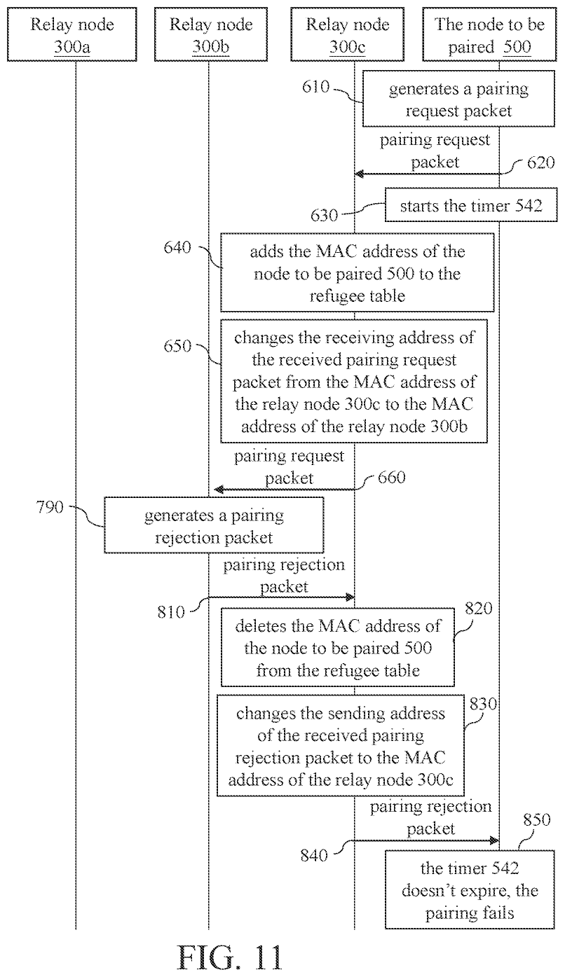

Please refer to FIG. 4 to FIG. 6 and FIG. 11, wherein FIG. 11 is a flowchart of a second embodiment of a method for pairing nodes in which the node to be paired in FIG. 6 joins the mesh network system in FIG. 4. Since the difference between FIG. 11 and FIGS. 7-8 lies in the process after the relay node 300b determines that it cannot provide the relay service for the node to be paired 500, the description of the process from step 610 to step 660 will not be repeated. As shown in FIG. 11, after the relay node 300b determines that it cannot provide the relay service for the node to be paired 500 by the processing circuit 430 thereof, the relay node 300b generates a pairing rejection packet by the packet generation circuit 440 thereof (step 790), and sends the pairing rejection packet to the relay node 300c by the sending circuit 460 thereof (step 810), wherein the receiving address of the pairing rejection packet is the MAC address of the node to be paired 500 and the sending address of the pairing rejection packet is the MAC address of the relay node 300b. After the relay node 300c confirms that the sending address of the pairing rejection packet is the MAC address of its parent node by the processing circuit 430 thereof, and the receiving address of the pairing rejection packet is contained in the refugee table stored in the storage circuit 410 of the relay node 300c, the relay node 300c deletes the MAC address of the node to be paired 500 from the refugee table stored in the storage circuit 410 of the relay node 300c (step 820). Then, the relay node 300c changes the sending address of the received pairing rejection packet to the MAC address of the relay node 300c by the address change circuit 450 thereof (step 830). After that, the relay node 300c sends the pairing rejection packet whose sending address is changed by the address change circuit 450 to the node to be paired 500 by the sending circuit 460 thereof (step 840).

Since the receiving address of the pairing rejection packet is the MAC address of the node to be paired 500, the node to be paired 500 receives the pairing rejection packet by the receiving circuit 530 thereof. If the receiving circuit 530 of the node to be paired 500 receives the pairing rejection packet, and the timer 542 of the node to be paired 500 does not expire, it means that the pairing fails (step 850) (that is, the node to be paired 500 fails to join the mesh network system 100).

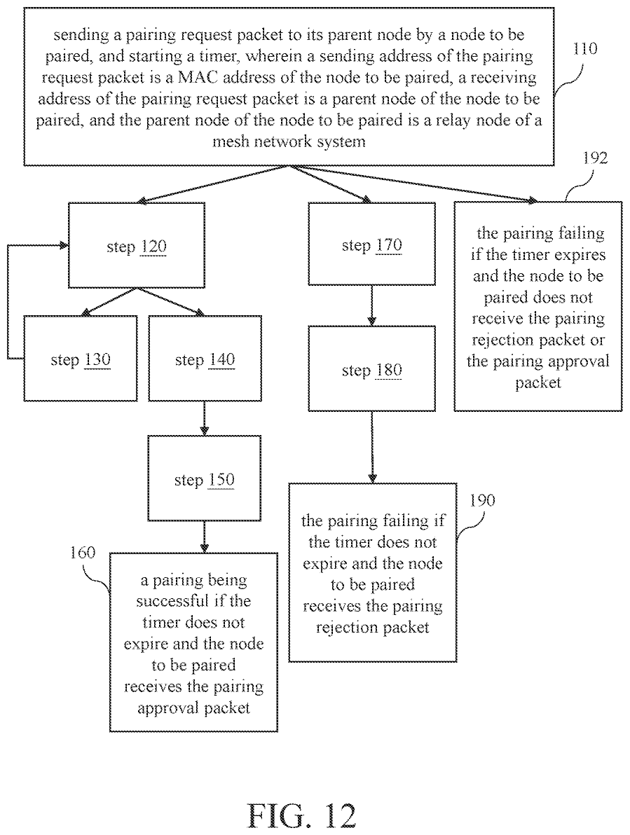

Please refer to FIG. 12, which is a flowchart of a method for pairing nodes according to a third embodiment of the present disclosure. In addition to step 110 to step 190, the method for pairing nodes may further comprise: the pairing failing if the timer expires and the node to be paired does not receive the pairing rejection packet or the pairing approval packet (step 192).

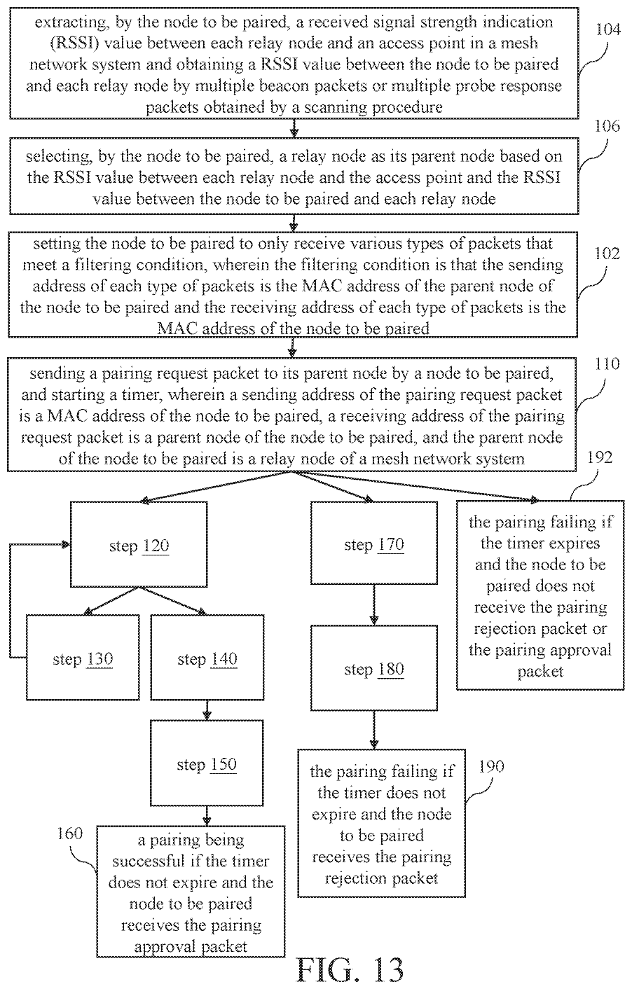

In one embodiment, please refer to FIG. 13, which is a flowchart of a method for pairing nodes according to a fourth embodiment of the present disclosure. Before step 110, the method for pairing nodes may further comprise: setting the node to be paired to only receive various types of packets that meet a filtering condition, wherein the filtering condition is that the sending address of each type of packets is the MAC address of the parent node of the node to be paired and the receiving address of each type of packets is the MAC address of the node to be paired (step 102).

In one embodiment, please refer to FIG. 13, before step 102, the method for pairing nodes may further comprise: extracting, by the node to be paired, a received signal strength indication (RSSI) value between each relay node and an access point in a mesh network system and obtaining a RSSI value between the node to be paired and each relay node by multiple beacon packets or multiple probe response packets obtained by a scanning procedure (step 104); and selecting, by the node to be paired, a relay node as its parent node based on the RSSI value between each relay node and the access point and the RSSI value between the node to be paired and each relay node (step 106).

In an example, the scanning procedure is that the node to be paired actively detects and searches each relay node of the mesh network system. Specifically, the node to be paired may send probe request frames sequentially on the channels it supports, wherein the probe request frame does not carry the SSID but may comprise vendor-defined information elements (Vendor IEs), such as the BSSID and the information requesting assistance, to detect all available relay nodes around. The relay node receiving the probe request frame sends a probe response frame to the node to be paired, wherein the probe response frame may comprise Vendor IEs, such as the BSSID, the RSSI value between itself and the access point, the MAC address of the root node it is coupled to, the number of levels it is at in the mesh network system, the number of descendant nodes that provided with relay services by itself, and information that it can provide assistance. Therefore, the node to be paired can receive the probe response frame sent by each relay node through the above scanning procedure, and obtain the RSSI value between itself and each relay node and the RSSI value between each relay node and the access point, and then select a relay node as its parent node. For example, the node to be paired first selects the relay node with the best RSSI value as its parent node, but if the RSSI value between the selected relay node and the parent node thereof is poor or the RSSI value between the nodes on the uplink path of the selected relay node is poor, the node to be paired chooses the relay node with the second best RSSI value as its parent node, and so on, until the node to be paired selects a suitable relay node as its parent node.

In another example, the scanning procedure is that the node to be paired passively receives the beacon frame sent by each relay node of the mesh network system. Specifically, each relay node of the mesh network system periodically broadcasts the beacon frame, and the node to be paired can listen to the beacon frames on each channel it supports, wherein the beacon frame can comprise Vendor IEs, such as the B S SID, the RSSI value between itself and the access point, the MAC address of the root node it is coupled to, the number of levels it is at in the mesh network system, the number of descendant nodes that provided with relay services by itself, and information that it can provide assistance. Therefore, the node to be paired can receive the probe response frame sent by each relay node through the above scanning procedure, and obtain the RSSI value between the node to be paired and each relay node and the RSSI value between each relay node and the access point, and then select a relay node as its parent node.

Through the methods for pairing nodes described in FIG. 1, FIG. 9, FIG. 12 and FIG. 13, the network node as the non-root node (that is, the node to be paired) can confirm its parent node and join the mesh network system, and each relay node of the mesh network system can update the content of the refugee table stored by itself, so as to construct the mesh network system.

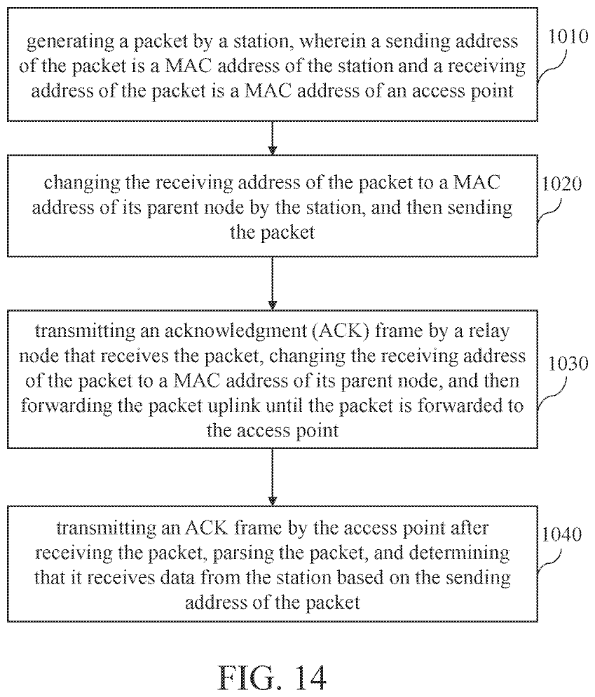

Please refer to FIG. 14, which is a flowchart of a data transmission method according to a first embodiment of the present disclosure. The data transmission method comprises: generating a packet by a station, wherein a sending address of the packet is a MAC address of the station and a receiving address of the packet is a MAC address of an access point (step 1010); changing the receiving address of the packet to a MAC address of its parent node by the station, and then sending the packet (step 1020); transmitting an acknowledgment (ACK) frame by a relay node that receives the packet, changing the receiving address of the packet to a MAC address of its parent node, and then forwarding the packet uplink until the packet is forwarded to the access point (step 1030); and transmitting an ACK frame by the access point after receiving the packet, parsing the packet, and determining that it receives data from the station based on the sending address of the packet (step 1040).

Generally, network integrated circuits (ICs) mainly process data in a physical layer (i.e., Layer 1) and a data link layer (i.e., Layer 2) with hardware, and process data in above Layer 3 with software. However, with the increasing demand for bandwidth, the requirements for the transmission rate of routers have also increased significantly. Therefore, it is also possible to choose to process the data of the third layer by hardware for the network ICs. In this embodiment, the station can include a software layer and a hardware layer, so in step 1010, the station can generate a packet by the software layer, and in step 1020, the station can change the receiving address of the packet to the MAC address of its parent node by the hardware layer, and then send the packet. In another embodiment, the station can change the receiving address of the packet to the MAC address of its parent node by the software layer, and then send the packet.

In one embodiment, the format of the packet generated by the software layer of the station may use a frame defined by the 802.11 protocol, such as a data frame, a management frame, a control frame, and other self-defined frames.

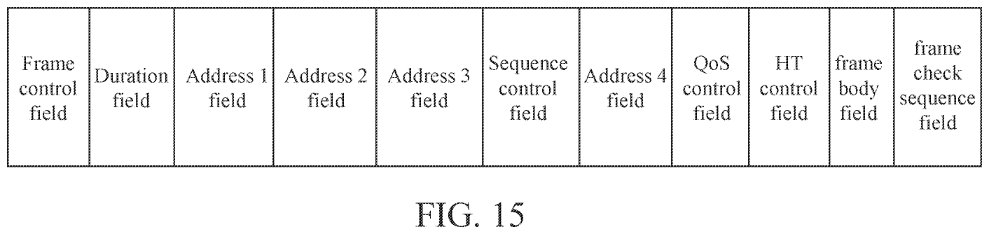

In one embodiment, the format of the packet generated by the software layer of the station may be a data frame defined by the 802.11 protocol, and the data frame comprises a frame control field, a duration field, an address 1 field, an address 2 field, an address 3 field, a sequence control field, an address 4 field, a quality of service (QoS) control field, a high throughput (HT) control field, a frame body field, and a frame check sequence (FCS) field, as shown in FIG. 15, which is a schematic diagram of a format of a packet generated by a station according to an embodiment of the present disclosure. Specifically, the software layer of the station fills the address 1 field in the data frame with the MAC address of the access point, and fills the address 2 field with the MAC address of itself to generate the packet, but this embodiment is not intended to limit the present disclosure. For example, the software layer of the station fills the address 3 field in the data frame with the MAC address of the access point, and fills the address 4 field with the MAC address of itself to generate the packet (that is, the address 3 field is filled with the receiving address, and the address 4 field is filled with the sending address).

In one embodiment, in order to consider the security of data transmission, the data transmission method may be further performed by encrypting the packet at the station, and decrypting the packet at the access point. Specifically, when the encryption and decryption method is performed by using the Temporal Key Integrity Protocol (TKIP), the Counter Mode Cipher Block Chaining Message Authentication Protocol (CCMP) or the Wired Equivalent Privacy Protocol (WEP), step 1010 may comprise: generating the packet by the software layer of the station, and then encrypting the packet, or step 1020 may comprise: changing, by the hardware layer of the station, the receiving address of the packet to the MAC address of its parent node after the hardware layer of the station encrypts the packet, and then sending the packet; step 1040 may comprise: decrypting, by the access point, the packet received, and then determining that it receives the data from the station based on the sending address of the packet being the MAC address of the station. In an example, the station may encrypt the packet by the software layer or the hardware layer, then change the receiving address of the packet to the MAC address of its parent node, and then send the packet.

In another embodiment, when the encryption and decryption method is performed by using the TKIP or WEP, step 1020 may comprise: encrypting, by the station, the packet after the station changes the receiving address of the packet to the MAC address of its parent node, and then sending the packet; step 1040 may comprise: decrypting, by the access point, the packet received, and then determining that it receive the data from the station based on the sending address of the packet being the MAC address of the station.

In one embodiment, in order to ensure the correctness and integrity of data transmission, the data transmission method may use a cyclic redundancy check (CRC) algorithm to check the packet. Specifically, step 1020 may comprise: performing, by the station, CRC calculation on the packet, and fill a calculated CRC code into the packet after the station changes the receiving address of the packet to the MAC address of its parent node, and then sending the packet; step 1030 may comprise: performing, by the relay node receiving the packet, CRC check on the packet, returning an ACK frame when the packet passes the CRC check, changing the receiving address of the packet received to the MAC address of its parent node, performing CRC calculation on the packet, filling a calculated CRC code into the packet, and then forwarding the packet uplink until the packet is forwarded to the access point; step 1040 may comprise: performing, by the access point, CRC check on the packet after the access point receives the packet, returning an ACK frame when the packet passes the CRC check, and then parsing the packet to obtain the data from the station.

In another embodiment where the CRC check algorithm is used to check the packet, step 1020 may comprise: performing, by of the station, CRC calculation on the packet, filling a calculated CRC code into the packet, changing the receiving address of the packet to the MAC address of its parent node, and then sending the packet; step 1030 may comprise: changing, by the relay node receiving the packet, the receiving address of the packet to the MAC address of the access point, performing CRC check on the packet, returning an ACK frame when the packet passes the CRC check, changing the receiving address of the packet to the MAC address of its parent node (the packet retains the original CRC code), and then forwarding the packet uplink until the packet is forwarded to the access point; step 1040 may comprise: performing, by the access point, CRC check on the packet after the access point receives the packet, returning an ACK frame when the packet passes the CRC check, and then parsing the packet to obtain the data from the station.

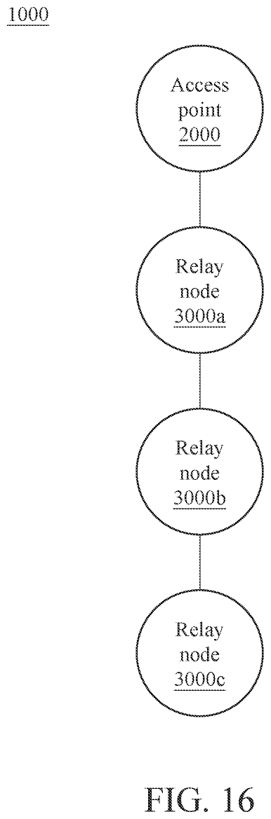

In one embodiment, in order to consider the security, correctness and integrity of data transmission at the same time, the data transmission method may comprise the encryption and decryption of the data field of the packet and the check of the packet by using the CRC algorithm. For example, the description of the data transmission method is carried out in the manner of an embodiment with reference to FIG. 16 to FIG. 19.

Please refer to FIG. 16, which is a schematic diagram of a mesh network system according to another embodiment of the present disclosure. As shown in FIG. 16, the mesh network system 1000 comprises an access point 2000 and a plurality of network nodes, the plurality of network nodes may be coupled to and communicate with each other in a tree topology, and the plurality of network nodes comprise a plurality of relays nodes (that is, the relay node 3000a, the relay node 3000b, and the relay node 3000c), wherein the relay node 3000a serves as the root node communicating with the access point 2000, the parent node of the relay node 3000c is the relay node 3000b, and the parent node of the relay node 3000b is the relay node 3000a (that is, the relay node 3000a, the relay node 3000b and the relay node 3000c are hierarchically connected).

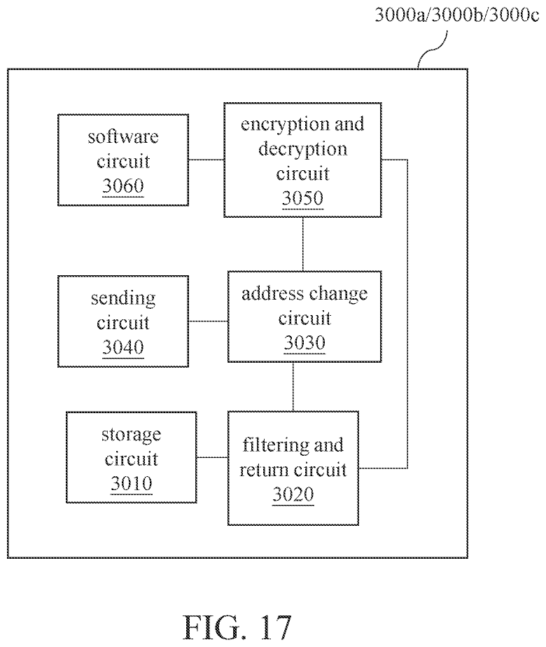

Please refer to FIG. 17, which is a schematic diagram of a relay node according to another embodiment of the present disclosure. The relay node 3000a, the relay node 3000b, and the relay node 3000c may all have the relay function and the STA function, and each of the relay node 3000a, the relay node 3000b, and the relay node 3000c may comprise a storage circuit 3010, a filtering and return circuit 3020, an address change circuit 3030, a sending circuit 3040, an encryption and decryption circuit 3050 and a software circuit 3060, wherein filtering and return circuit 3020 is coupled to the storage circuit 3010, the address change circuit 3030 is coupled to filtering and return circuit 3020, the sending circuit 3040 is coupled to the address change circuit 3030, the encryption and decryption circuit 3050 is coupled to the address change circuit 3030, filtering and the return circuit 3020 and the software circuit 3060, and the storage circuit 3010 is used for storing the refugee table. The content of the refugee table stored in the storage circuit 3010 of the relay node 3000a contains the MAC address of the relay node 3000b and the MAC address of the relay node 3000c, and the content of the refugee table stored in the storage circuit 3010 of the relay node 3000b contains the MAC address of the relay node 3000c. In addition, the filtering and return circuit 3020, the address translation circuit 3030, the sending circuit 3040 and the encryption and decryption circuit 3050 can be implemented as software, hardware, and an appropriate combination thereof. In this embodiment, the filtering and return circuit 3020, the address change circuit 3030, the sending circuit 3040, and the encryption and decryption circuit 3050 can be located in the hardware layer, and the software circuit 3060 can be located in the software layer, but this embodiment is not intended to limit the present disclosure.

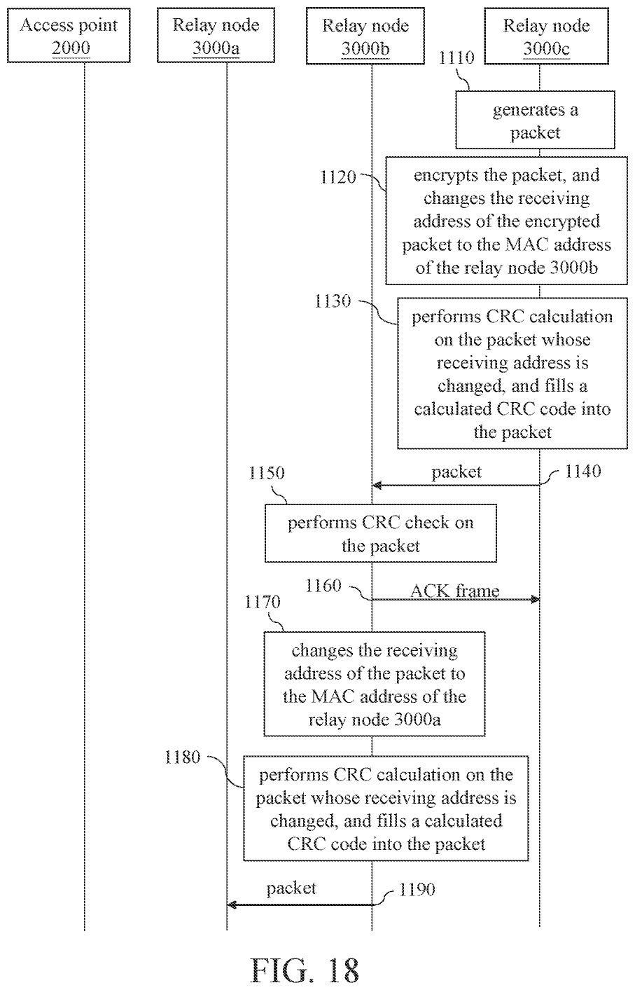

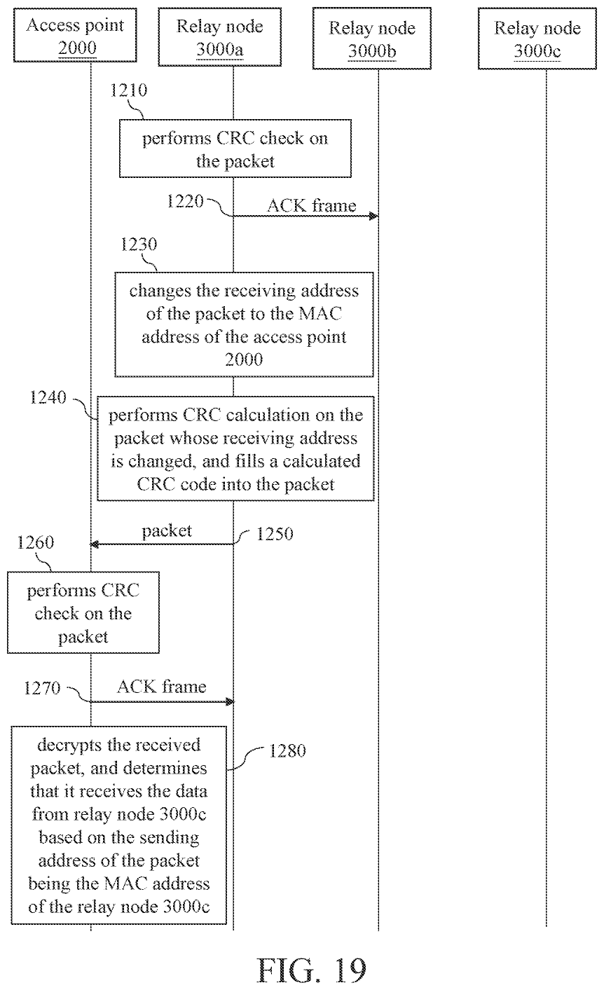

Please refer to FIGS. 16 to 19, wherein FIGS. 18 and 19 are a flowchart of an embodiment of a data transmission method in which a third-level node transmits a packet to an access point in FIG. 16. The third-level node is a relay node 3000c, the relay node 3000c acts as a station, and the relay node 3000a and the relay node 3000b can provide the relay service for the relay node 3000c.

The relay node 3000c generates a packet by the software circuit 3060 thereof, wherein the receiving address of the packet is the MAC address of the access point 2000 and the sending address of the packet is the MAC address of the relay node 3000c (step 1110). The relay node 3000c encrypt the packet generated by the software circuit 3060 by the encryption and decryption circuit 3050 thereof, and then sends the packet to the address change circuit 3030 thereof, so that the relay node 3000c changes the receiving address of the encrypted packet to the MAC address of the relay node 3000b by the address change circuit 3030 thereof (step 1120), and then the sending circuit 3040 of the relay node 3000c performs CRC calculation on the packet whose receiving address is changed by the address change circuit 3030, fills a calculated CRC code into the packet (step 1130), and then sends the packet to the relay node 3000b (step 1140).

Based on the receiving address of the packet being the MAC address of the relay node 3000b, the relay node 3000b receives the packet by the filter and return circuit 3020 thereof, and then performs CRC check on the packet (step 1150). When the packet passes the CRC check, the relay node 3000b returns an ACK frame to the relay node 3000c (step 1160). In addition, when the relay node 3000b further determines that the packet needs to be forwarded uplink by the filtering and return circuit 3020 thereof, the relay node 3000b changes the receiving address of the packet to the MAC address of the relay node 3000a by the address change circuit 3030 thereof (step 1170). Then, the sending circuit 3040 of the relay node 3000b performs CRC calculation on the packet whose receiving address has been changed by the address change circuit 3030 of the relay node 3000b, and fills a calculated CRC code into the packet (step 1180), and then forwards the packet uplink to the relay node 3000a (step 1190).

Based on the receiving address of the packet being the MAC address of the relay node 3000a, the relay node 3000a receives the packet by the filter and return circuit 3020 thereof, and performs CRC check on the packet (step 1210). When the packet passes the CRC check, the relay node 3000a returns an ACK frame to the relay node 3000b (step 1220). In addition, when the relay node 3000a further determines that the packet needs to be forwarded uplink by the filtering and return circuit 3020 thereof, the relay node 3000a changes the receiving address of the packet to the MAC address of the access point 2000 by the address change circuit 3030 thereof (step 1230). Then, the sending circuit 3040 of the relay node 3000a performs CRC calculation on the packet whose receiving address has been changed by the address change circuit 3030, and fills a calculated CRC code into the packet (step 1240), and then forwards the packet uplink to the access point 2000 (step 1250).

Based on the receiving address of the packet being the MAC address of the access point 2000, the access point 2000 receives the packet and performs CRC check on the packet (step 1260). When the packet passes through the CRC check, the access point 2000 returns an ACK frame to the relay node 3000a (step 1270), and decrypts the received packet, and determines that it receives the data from relay node 3000c based on the sending address of the packet being the MAC address of the relay node 3000c (step 1280).

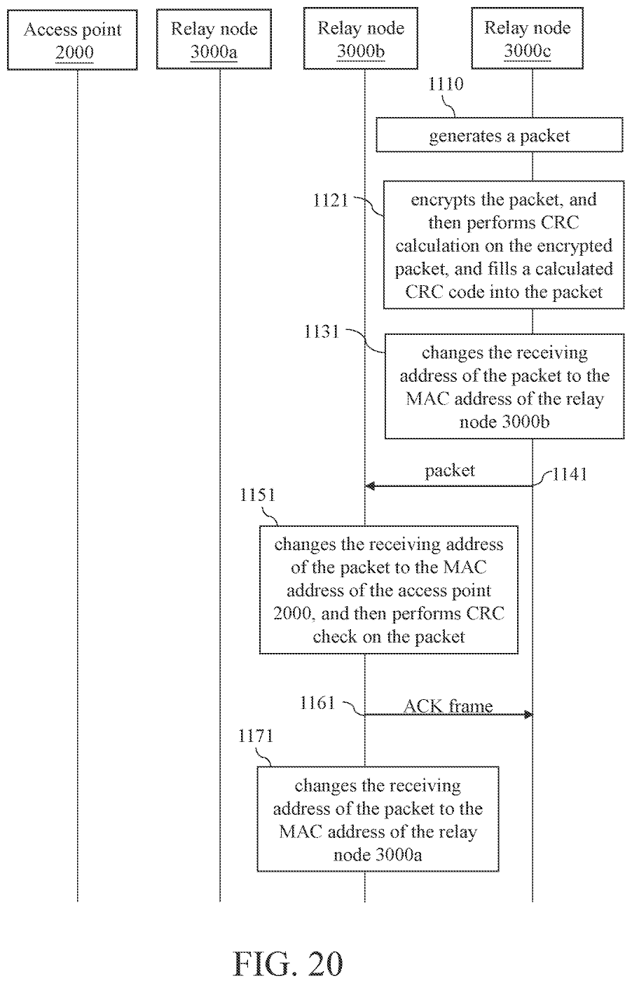

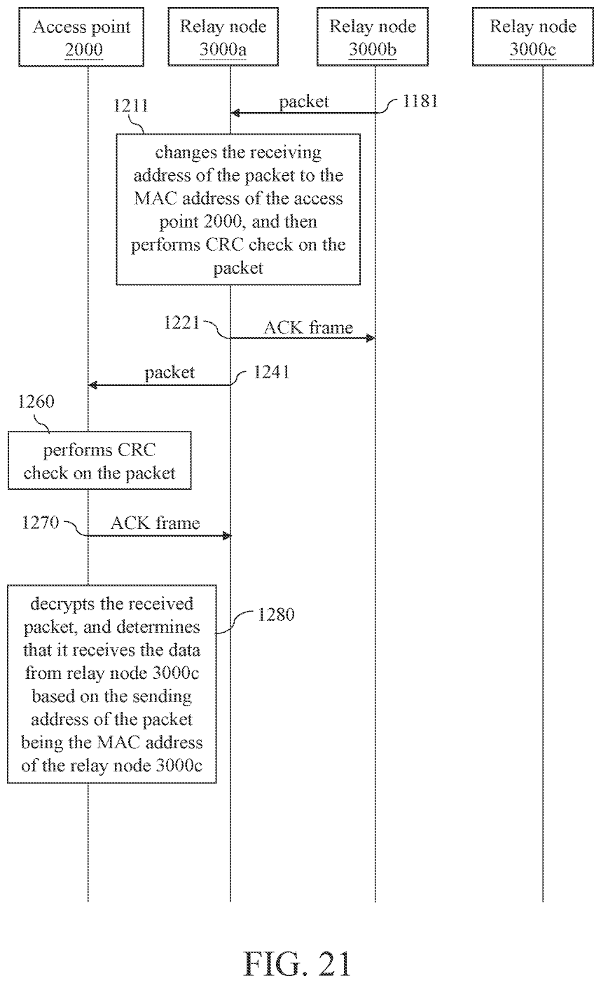

Please refer to FIG. 16, FIG. 17 and FIGS. 20-21. FIGS. 20-21 are a flowchart of another embodiment of a data transmission method in which a third-level node transmits a packet to an access point in FIG. 16, wherein the third-level node is the relay node 3000c, the relay node 3000c act as a station, and the relay node 3000a and the relay node 3000b can provide the relay service for the relay node 3000c.

The relay node 3000c generates a packet by the software circuit 3060 thereof, wherein the receiving address of the packet is the MAC address of the access point 2000 and the sending address of the packet is the MAC address of the relay node 3000c (step 1110). The relay node 3000c encrypts the packet generated by the software circuit 3060 by the encryption and decryption circuit 3050 thereof, and sends the packet to the filtering and return circuit 3020 thereof, so that the filtering and return circuit 3020 of the relay node 3000c performs CRC calculation on the encrypted packet, and fills a calculated CRC code into the packet (step 1121). Then, the address change circuit 3030 of the relay node 3000c changes the receiving address of the packet to the MAC address of the relay node 3000b (step 1131), and then the sending circuit 3040 of the relay node 3000c sends the packet to the relay node 3000b (step 1141).

Based on the receiving address of the packet being the MAC address of the relay node 3000b, the relay node 3000b receives the packet, and changes the receiving address of the packet to the MAC address of the access point 2000 by the address change circuit 3030 thereof, and then performs CRC check on the packet by the filtering and return circuit 3020 thereof (step 1151). When the packet passes the CRC check, the relay node 3000b returns an ACK frame to the relay node 3000c (step 1161). In addition, when the relay node 3000b further determines that the packet needs to be forwarded uplink by the filtering and return circuit 3020 thereof, the relay node 3000b changes the receiving address of the packet to the MAC address of the relay node 3000a by the address change circuit 3030 thereof (step 1171), and then forwards the packet uplink to the relay node 3000a by the sending circuit 3040 thereof (step 1181).

Based on the receiving address of the packet being the MAC address of the relay node 3000a, the relay node 3000a receives the packet, and changes the receiving address of the packet to the MAC address of the access point 2000 by the address change circuit 3030 thereof, and then performs CRC check on the packet by the filtering and return circuit 3020 thereof (step 1211). When the packet passes the CRC check, the relay node 3000a returns an ACK frame to the relay node 3000b (step 1221). In addition, when the relay node 3000a further determines that the packet needs to be forwarded uplink by the filtering and return circuit 3020 thereof, the relay node 3000a changes the receiving address of the packet to the MAC address of its parent node by the address change circuit 3030 thereof (since the parent node of the relay node 3000a is the access point 2000, this step can be omitted), and forwards the packet to the access point 2000 by the sending circuit 3040 thereof (step 1241).

Based on the receiving address of the packet being the MAC address of the access point 2000, the access point 2000 receives the packet and performs CRC check on the packet (step 1260). When the packet passes through the CRC check, the access point 2000 returns an ACK frame to the relay node 3000a (step 1270), decrypts the received packet, and then determines that it receives the data from relay node 3000c based on the sending address of the packet being the MAC address of the relay node 3000c (step 1280).

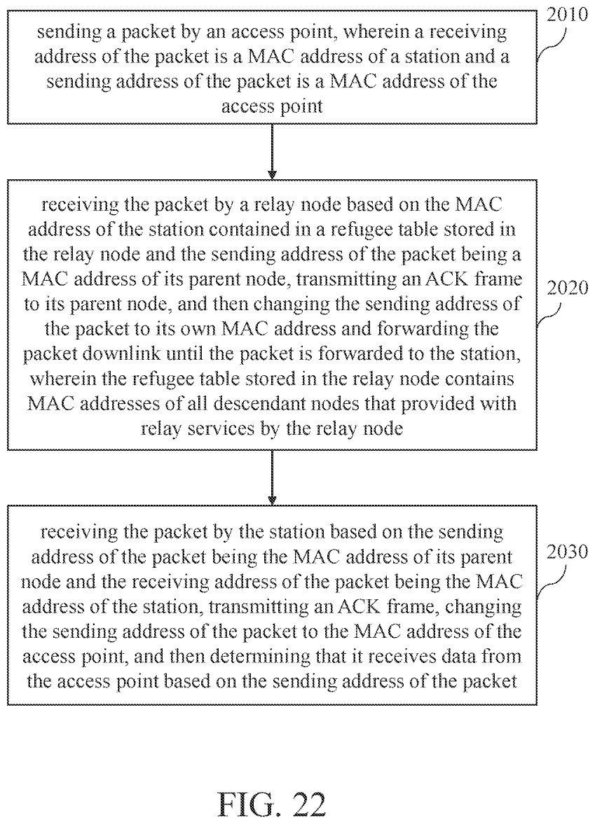

Please refer to FIG. 22, which is a flowchart of a data transmission method according to a second embodiment of the present disclosure. The data transmission method comprises: sending a packet by an access point, wherein a receiving address of the packet is a MAC address of a station and a sending address of the packet is a MAC address of the access point (step 2010); receiving the packet by a relay node based on the MAC address of the station contained in a refugee table stored in the relay node and the sending address of the packet being a MAC address of its parent node, transmitting an ACK frame to its parent node, and then changing the sending address of the packet to its own MAC address and forwarding the packet downlink until the packet is forwarded to the station, wherein the refugee table stored in the relay node contains MAC addresses of all descendant nodes that provided with relay services by the relay node (step 2020); and receiving the packet by the station based on the sending address of the packet being the MAC address of its parent node and the receiving address of the packet being the MAC address of the station, transmitting an ACK frame, changing the sending address of the packet to the MAC address of the access point, and then determining that it receives data from the access point based on the sending address of the packet (step 2030).

In one embodiment, the format of the packet sent by the access point may be a data frame defined by the 802.11 protocol, such as a management frame, a control frame, and other self-defined frames.

In one embodiment, the station may include a hardware layer and a software layer, so in step 2030, the station may receive the packet by the hardware layer, return the ACK frame, and change the sending address of the received packet to the MAC address of the access point by the hardware layer or the software layer, and the software layer of the station may determine to receive data from the access point based on the sending address of the packet.

In one embodiment, the format of the packet sent by the access point may be a data frame defined by the 802.11 protocol as shown in FIG. 15. Specifically, the access point fills the address 1 field in the data frame with the MAC address of the station, and fills the address 2 field with the MAC address of itself to generate the packet, but this embodiment is not intended to limit the present disclosure. For example, the access point fills the address 3 field in the data frame with the MAC address of the station, and fills the address 4 field with the MAC address of itself to generate the packet (that is, the address 3 field is filled with the receiving address, and the address 4 field is filled with the sending address).

In one embodiment, in order to consider the security of data transmission, the data transmission method may be further performed by encrypting the packet at the access point, and decrypting the packet at the station. Specifically, step 2010 may comprise: encrypting, by the access point, the packet, and then sending the packet; step 2030 may comprise: changing, by the station, the sending address of the packet to the MAC address of the access point after the station decrypts the packet, and then determining that it receives the data from the access point based on the sending address of the packet. In another embodiment, step 2010 may comprise: encrypting, by the access point, the packet and then sending the packet; step 2030 may comprise: changing, by the station, the sending address of the received packet to the MAC address of the access point; and decrypting, the station, the packet, and determining that it receive the data from the access point based on the sending address of the packet.

In one embodiment, in order to ensure the correctness and integrity of data transmission, the data transmission method may use the CRC algorithm to check the packet. Specifically, step 2010 may comprise: performing, by the access point, CRC calculation on the packet, filling a calculated CRC code into the packet, and then sending the packet; step 2020 may comprise: performing, by the relay node receiving the packet, CRC check on the packet, returning an ACK frame when the packet passes the CRC check, changing the sending address of the packet to the MAC address of itself, performing CRC calculation on the packet, filling a calculated CRC code into the packet, and then forwarding the packet downlink; step 2030 may comprise: performing, by the station, CRC check on the packet, returning an ACK frame when the packet passes the CRC check, changing the sending address of the packet to the MAC address of the access point, and then determining that it receives the data from the access point based on the sending address of the packet.

In another embodiment where the CRC check algorithm is used to check the packet, step 2010 may comprise: performing, by the access point, CRC calculation on the packet, filling a calculated CRC code into the packet, and then sends the packet; step 2020 may comprise: performing, by the relay node receiving the packet, CRC check on the packet, returning an ACK frame when the packet passes the CRC check, changing the sending address of the packet to the MAC address of itself (the packet retains the original CRC code) and then forwarding the packet downlink; step 2030 may comprise: changing, by the station, the sending address of the packet to the MAC address of the access point, performing CRC check on the packet, returning an ACK frame when the packet passes the CRC check, and then determining that it receives the data from the access point based on the sending address of the packet that passes the CRC check.

In one embodiment, in order to consider the security, correctness and integrity of data transmission at the same time, the data transmission method may comprise the encryption and decryption of the data field of the packet and the check of the packet by using the CRC algorithm. For example, the description of the data transmission method is carried out in the manner of an embodiment with reference to FIG. 16, FIG. 17 and FIGS. 23-24.

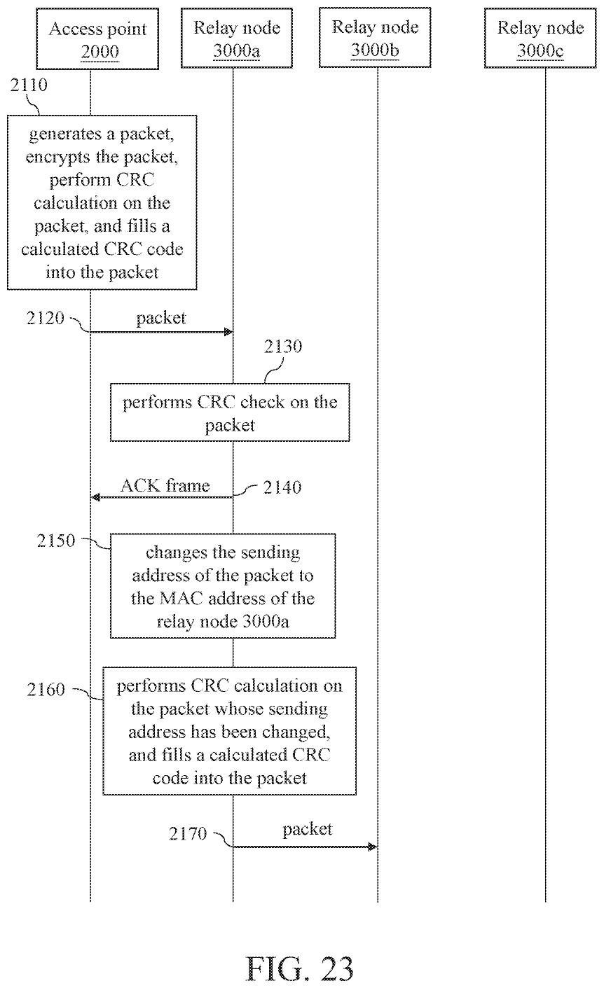

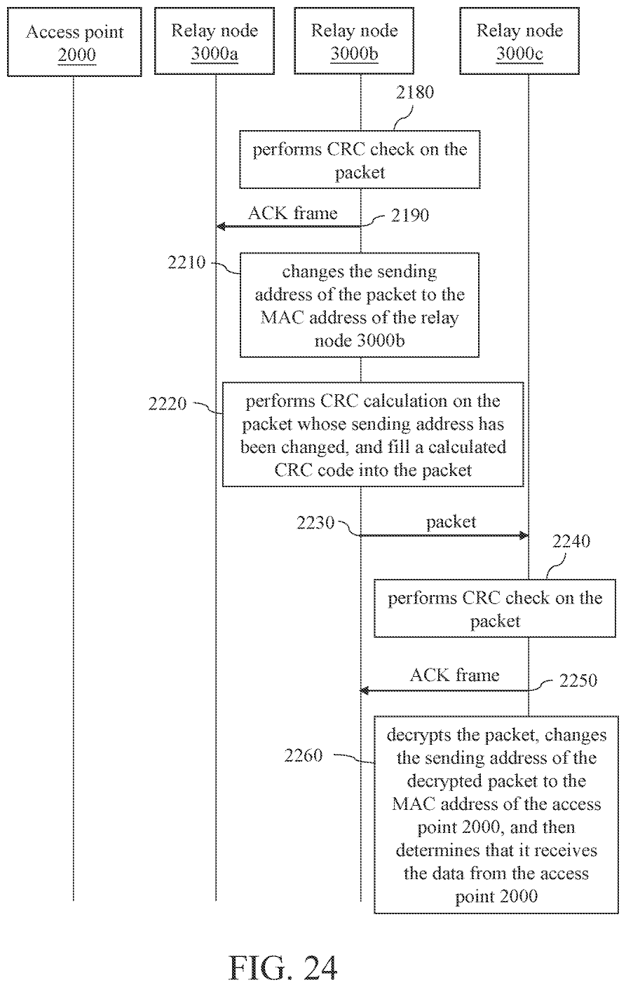

Please refer to FIG. 16, FIG. 17 and FIGS. 23-24, wherein FIGS. 23 and 24 are a flowchart of an embodiment of a data transmission method in which an access point transmits a packet to a third-level node in FIG. 16, the third-level node is the relay node 3000c, the relay node 3000c acts as a station, and the relay node 3000a can provide relay services for the relay node 3000b and the relay node 3000c (that is, the content of the refugee table of the relay node 3000a contains the MAC address of the relay node 3000b and the MAC address of the relay node 3000c), the relay node 3000b can provide the relay service for the relay node 3000c (that is, the content of the refugee table of the relay node 3000b contains the MAC address of the relay node 3000c).

The access point 2000 generates a packet, encrypts the packet, performs CRC calculation on the packet, and fills a calculated CRC code into the packet (step 2110), and then sends the packet to the relay node 3000a (step 2120), wherein the receiving address of the packet is the MAC address of the relay node 3000c and the sending address of the packet is the MAC address of the access point 2000.

Based on the refugee table stored in the relay node 3000a and containing the MAC address of the relay node 3000c, and the sending address of the packet being the MAC address of the access point 2000, the relay node 3000a receives the packet and performs CRC check on the packet by the filtering and return circuit 3020 thereof (step 2130). When the packet passes the CRC check, the relay node 3000a returns an ACK frame to the access point 2000 (step 2140). In addition, the relay node 3000a further determines that the packet needs to be forwarded downlink by the filtering and return circuit 3020 thereof, so that the relay node 3000a changes the sending address of the packet to the MAC address of the relay node 3000a by the address change circuit 3030 thereof (step 2150), and then performs CRC calculation on the packet whose sending address has been changed by the address change circuit 3030 by the sending circuit 3040 thereof, and fills a calculated CRC code into the packet (step 2160), and then sends the packet to the relay node 3000b (step 2170).

Based on the refugee table stored in the relay node 3000b and containing the MAC address of the relay node 3000c, and the sending address of the packet being the MAC address of the relay node 3000a, the relay node 3000b receives the packet by the filter and return circuit 3020 thereof, and performing CRC check on the packet (step 2180). When the packet passes the CRC check, the relay node 3000b returns an ACK frame to the relay node 3000a (step 2190). In addition, the relay node 3000b further determines that the packet needs to be forwarded downlink by the filtering and return circuit 3020 thereof, so that the relay node 3000b changes the sending address of the packet to the MAC address of the relay node 3000b by the address change circuit 3030 thereof (step 2210). The sending circuit 3040 of the relay node 3000b performs CRC calculation on the packet whose sending address has been changed by the address change circuit 3030, and fill a calculated CRC code into the packet (step 2220), and then sends the packet to the relay node 3000c (step 2230).

Based on the sending address of the packet being the MAC address of the relay node 3000b and the receiving address of the packet being the MAC address of itself, the relay node 3000c receives the packet by the filtering and return circuit 3020 thereof, determines that the packet does not need to be forwarded, and performs CRC check on the packet (step 2240). When the packet passes the CRC check, the relay node 3000c returns an ACK frame to the relay node 3000b (step 2250). The relay node 3000c decrypts the packet by the encryption and decryption circuit 3050 thereof, and changes the sending address of the decrypted packet to the MAC address of the access point 2000 by the address change circuit 3030 thereof, and then transmits the packet to the software circuit 3060, so that the software circuit 3060 determines that it receives the data from the access point 2000 based on the sending address of the packet being the MAC address of the access point 2000 (step 2260).

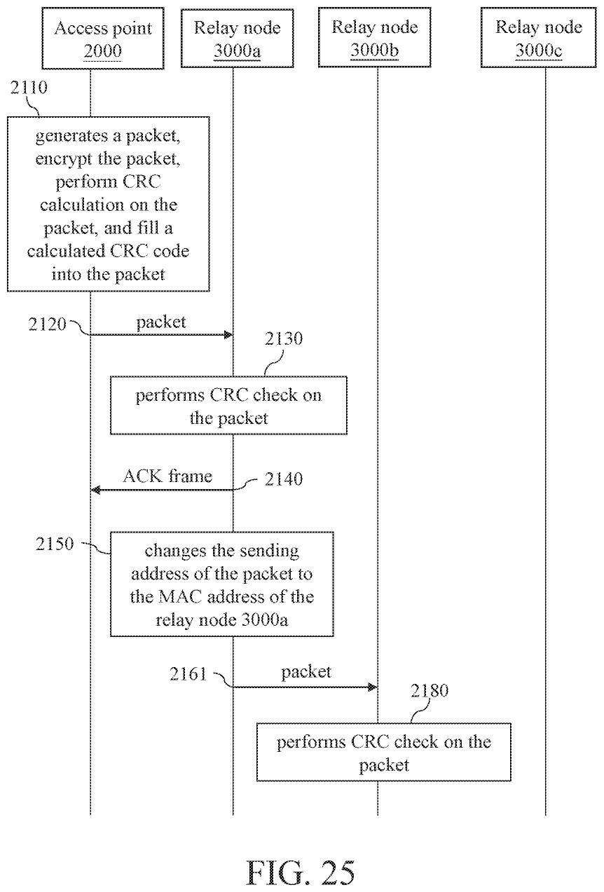

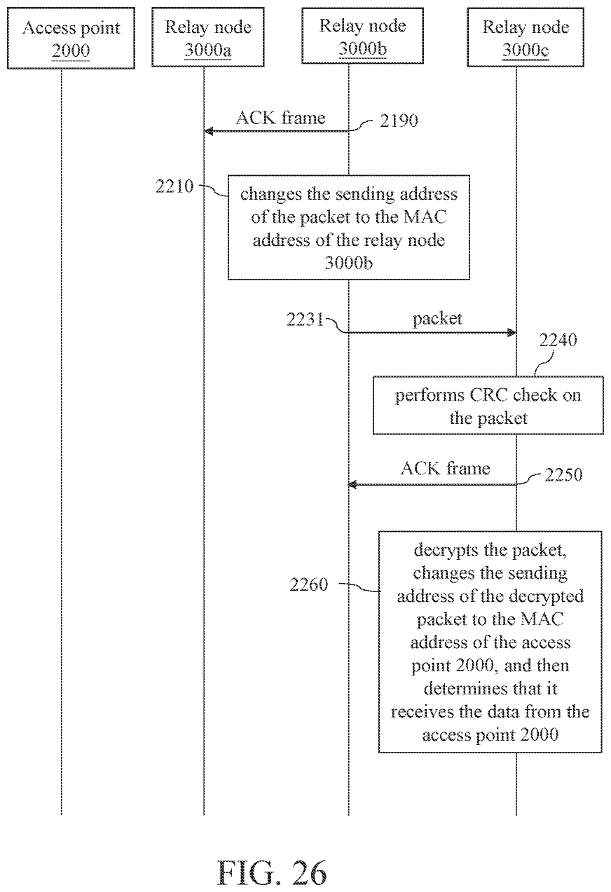

Please refer to FIG. 16, FIG. 17 and FIGS. 25-26, wherein FIGS. 25 and 26 are a flowchart of another embodiment of a data transmission method in which an access point transmits a packet to a third-level node in FIG. 16, the third-level node is the relay node 3000c, the relay node 3000c acts as a station, the relay node 3000a can provide the relay services for the relay node 3000b and the relay node 3000c, and the relay node 3000b can provide the relay service for the relay node 3000c.

The access point 2000 generates a packet, encrypts the packet, performs CRC calculation on the packet, and fills a calculated CRC code into the packet (step 2110), and then sends the packet to the relay node 3000a (step 2120), wherein the receiving address of the packet is the MAC address of the relay node 3000c and the sending address of the packet is the MAC address of the access point 2000.

Based on the refugee table stored in the relay node 3000a and containing the MAC address of the relay node 3000c, and the sending address of the packet being the MAC address of the access point 2000, the relay node 3000a receives the packet by the filtering and return circuit 3020 thereof, and performs CRC check on the packet (step 2130). When the packet passes the CRC check, the relay node 3000a returns an ACK frame to the access point 2000 (step 2140). In addition, when the relay node 3000a further determines that the packet needs to be forwarded downlink by the filtering and return circuit 3020, the relay node 3000a changes the sending address of the packet to the MAC address of the relay node 3000a by the address change circuit 3030 thereof (step 2150), and sends the packet to the relay node 3000b by the sending circuit 3040 thereof (step 2161).

Based on the refugee table stored in the relay node 3000b and containing the MAC address of the relay node 3000c, and the sending address of the packet being the MAC address of the relay node 3000a, the relay node 3000b receives the packet by the filtering and return circuit 3020 thereof, and performs CRC check on the packet (step 2180), wherein the sending address of the packet needs to be changed to the MAC address of the access point 2000 before the CRC check is performed. When the packet passes the CRC check, the relay node 3000b returns an ACK frame to the relay node 3000a (step 2190). In addition, when the relay node 3000b further determines that the packet needs to be forwarded downlink by the filtering and return circuit 3020 thereof, the relay node 3000b changes the sending address of the packet to the MAC address of the relay node 3000b by the address change circuit 3030 thereof (step 2210), and sends the packet to the relay node 3000c by the sending circuit 3040 thereof (step 2231).

Based on t the sending address of the packet being the MAC address of the relay node 3000b, and the receiving address of the packet is the MAC address of itself, the relay node 3000c receives the packet by the filtering and return circuit 3020 thereof, determines that the packet does not need to be forwarded, and performs CRC check on the packet (step 2240), wherein the sending address needs to be changed to the MAC address of the access point 2000 before the CRC check is performed. When the packet passes the CRC check, the relay node 3000c returns an ACK frame to the relay node 3000b (step 2250). The relay node 3000c decrypts the packet by the encryption and decryption circuit 3050 thereof, and changes the sending address of the decrypted packet to the MAC address of the access point 2000 by the address change circuit 3030 thereof, and then transmits the packet to the software circuit 3060, so that the software circuit 3060 determines that it receives the data from the access point 2000 based on the sending address of the packet being the MAC address of the access point 2000 (step 2260).

It should be noted that, if there is no causal relationship between the above steps, the present disclosure does not limit the order of execution thereof.

To sum up, in the embodiments of the present disclosure, the relay node implements data forwarding based on the modification of the receiving address or sending address of the packet, so that the data forwarding process does not involve encryption and decryption of packets, the routing table information does not need to be maintained, the logic is simple, there is no requirement for additional special protocols for the software, the relay node has the advantages of fast and high efficient, and the relay node solves the problem of relatively complicated data forwarding process in wireless networks. In addition, because there is no difference between the packets received or sent by the software layer of the station and the access point in the present disclosure and the packets received or sent by the station and the access point when there is no relay node between the point and the access point, neither the software layer of the station nor the software layer of the access point is aware of the existence of the relay node. Therefore, no special modifications to the packets are required in the software layer. Moreover, the format of the packet generated by the station or the access point may be a data frame defined by the 802.11 protocol, such as a management frame, a control frame, and other self-defined types of frames.

Although the above-described components are included in the drawings of the present disclosure, it is not excluded to use more other additional components to achieve better technical effects without departing from the spirit of the invention.

While the present disclosure is disclosed in the foregoing embodiments, it should be noted that these descriptions are not intended to limit the present disclosure. On the contrary, the present disclosure covers modifications and equivalent arrangements obvious to those skilled in the art. Therefore, the scope of the claims must be interpreted in the broadest manner to comprise all obvious modifications and equivalent arrangements.

What is claimed is:

1. A data transmission method, comprising the following steps:
(A) generating a packet by a station, wherein a sending address of the packet is a MAC address of the station and a receiving address of the packet is a MAC address of an access point;
(B) changing the receiving address of the packet to a MAC address of its parent node by the station, and then sending the packet;
(C) transmitting an acknowledgment (ACK) frame by a relay node that receives the packet, changing the receiving address of the packet to a MAC address of its parent node, and then forwarding the packet uplink until the packet is forwarded to the access point; and
(D) transmitting an ACK frame by the access point after receiving the packet, parsing the packet, and determining that it receives data from the station based on the sending address of the packet.

2. The data transmission method according to claim 1, wherein the step (A) comprises:
generating the packet by the station, and then encrypting the packet.

3. The data transmission method according to claim 2, wherein the step (D) comprises:
decrypting, by the access point, the packet received, and then determining that it receives the data from the station based on the sending address of the packet being the MAC address of the station.

4. The data transmission method according to claim 1, wherein the step (B) comprises:
changing the receiving address of the packet to the MAC address of its parent node after the station encrypts the packet, and then sending the packet.

5. The data transmission method according to claim 4, wherein the step (D) comprises:
decrypting, by the access point, the packet received, and then determining that it receives the data from the station based on the sending address of the packet being the MAC address of the station.

6. The data transmission method according to claim 1, wherein the step (B) further comprises: performing a cyclic redundancy check algorithm on the packet by the hardware layer of the station; and the step (C) further comprises: performing, by the relay node, a cyclic redundancy check on the packet received, and then transmitting the ACK frame only when the packet passes the cyclic redundancy check.

7. A data transmission method, comprising the following steps:
(a) sending a packet by an access point, wherein a receiving address of the packet is a MAC address of a station and a sending address of the packet is a MAC address of the access point;
(b) receiving the packet by a relay node based on the MAC address of the station contained in a refugee table stored in the relay node and the sending address of the packet being a MAC address of its parent node, transmitting an ACK frame to its parent node, and then changing the sending address of the packet to its own MAC address and forwarding the packet downlink until the packet is forwarded to the station, wherein the refugee table stored in the relay node contains MAC addresses of all descendant nodes that provided with relay services by the relay node; and
(c) receiving the packet by the station based on the sending address of the packet being the MAC address of its parent node and the receiving address of the packet being the MAC address of the station, transmitting an ACK frame, changing the sending address of the packet to the MAC address of the access point, and then determining that it receives data from the access point based on the sending address of the packet.

8. The data transmission method according to claim 7, wherein the step (a) comprises:
encrypting the packet by the access point, and then sending the packet.

9. The data transmission method according to claim 8, wherein the step (c) comprises:
changing the sending address of the packet to the MAC address of the access point after the station decrypts the packet, and then determining that it receives the data from the access point based on the sending address of the packet.

10. The data transmission method according to claim 8, wherein the step (c) comprises:
changing the sending address of the packet received to the MAC address of the access point by the station; and
decrypting the packet by the station, and then determining that it receives the data from the access point based on the sending address of the packet.

11. The data transmission method according to claim 7, wherein the step (a) further comprises: performing a cyclic redundancy check algorithm on the packet by the access point; the step (b) further comprises: performing a cyclic redundancy check on the packet by the relay node, and then transmitting the ACK frame only when the packet passes the cyclic redundancy check.

12. A mesh network system, comprising:
a station, configured to generate a packet, wherein a sending address of the packet is a MAC address of itself, and a receiving address of the packet is a MAC address of an access point; and further configured to change the receiving address of the packet to a MAC address of its parent node, and then send the packet;
a relay node, configured to perform an uplink forwarding procedure after receiving the packet, wherein the uplink forwarding procedure comprises: transmitting an ACK frame, changing the receiving address of the packet received to a MAC address of its parent node, and then forwarding the packet uplink; when the number of the relay nodes is multiple and hierarchically connected, each relay node executes the uplink forwarding procedure until the packet is forwarded to the access point; and
the access point, configured to transmit an ACK frame after receiving the packet, parse the packet, and then determine that it receives data from the station based on the sending address of the packet.

13. The mesh network system according to claim 12, wherein the station is further configured to generate the packet and encrypt the packet.

14. The mesh network system according to claim 12, the station is further configured to perform cyclic redundancy check algorithm calculation on the packet.

15. The mesh network system according to claim 12, wherein
the access point is further configured to send another packet, wherein a receiving address of the another packet is a MAC address of the station and a sending address of the another packet is the MAC address of the access point;
the relay node is further configured to perform a downlink forwarding procedure, wherein the downlink forwarding procedure comprises: receiving the another packet based on the MAC address of the station contained in a refugee table stored in the relay node and the sending address of the another packet being a MAC address of its parent node, transmitting an ACK frame to its parent node, and then changing the sending address of the another packet to a MAC address of itself and forwarding the another packet downlink; the refugee table stored in the relay node contains MAC addresses of all descendant nodes that provided with relay services by the relay node; when the number of the relay nodes is multiple and hierarchically connected, each relay node executes the downlink forwarding procedure until the another packet is forwarded to the station;
the station is further configured to receive the another packet based on the sending address of the another packet being a MAC address of its parent node and the receiving address of the another packet being a MAC address of itself, transmit an ACK frame, change the sending address of the another packet received to the MAC address of the access point, and then determine that it receives data from the access point based on the sending address of the another packet.

16. The mesh network system according to claim 15, wherein the access point is further configured to encrypt the another packet.

17. The mesh network system according to claim 15, wherein the access point is further configured to perform cyclic redundancy check algorithm calculation on the another packet.
